(19) United States
(12) Patent Application Publication
(10) Pub. No.: US 2010/0306336 A1
(43) Pub. Date: Dec. 2, 2010

(54) Communication System

(75) Inventor: KARL WEBER, Altdorf (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/788,598

(22) Filed: May 27, 2010

(30) Foreign Application Priority Data
May 29, 2009 (DE) 10 2009 023 199.4

(51) Int. Cl. G06F 15/16; G06F 12/00; G06F 15/167

(52) U.S. Cl. 709/212; 711/154; 709/231; 711/E12.001

(57) ABSTRACT

The invention relates to a data communication method which is based on a layer model, the layer model (1) having a media-independent interface (10), a memory (12) having one check bit (14), two check bits (16) or a plurality of check bits (14, 16) which are statically or dynamically set, at least one check bit (14, 16) being checked during a direct memory access process, and the contents of a memory cell being identified as entry to a function depending on whether or not the check bit (14, 16) has been set.

The invention relates to a communication system. Communication systems are based on hardware and/or software. Communication by means of a communication system may be wired (for example via a copper cable or via a fiber-optic cable) or else wireless (for example via a radio link). Communication systems are used, for example, to transmit audio data or else video data. Automation technology is another field of application of communication systems. Automation technology can be used to control or regulate industrial systems. Real-time systems are very important both in automation technology and in telecommunications. The aim of real-time systems is excellent communication performance. In the field of industrial systems, another demand imposed on the communication system may be that of the communication system having a high degree of availability and/or robustness, in particular in the area of field communication. Added to this is then often also the demand for simple use in a multiplicity of system environments and a certain degree of flexibility in order to concomitantly take up current trends.

One object of the present invention is to improve a communication system. This relates, in particular, to a communication system which is subject to or satisfies real-time demands. Even in the area of Ethernet, there are also repeatedly innovations or new applications which need to be managed.

Ethernet-based communication systems can be used in the area of field communication. A field bus, for example, is used in field communication. A field bus is an industrial communication system which connects a multiplicity of field devices such as sensors (for example measuring sensors) and actuators (for example drives) to a control device (for example a PLC (programmable logic controller), a master computer or a drive control system). In this case, the control device is intended for control and/or regulating functionalities. Field bus technology is standardized, inter alia, in the IEC 61158 standard (“Digital data communication for measurement and control—Fieldbus for use in industrial control systems”). The field bus networks components distributed over a field (for example a system or a machine).

Data communication, including that of a field bus, can be structured entirely or else partially using an OSI layer model. The Open Systems Interconnection Reference Model (OSI model) was developed as the basis for designing communication protocols. This model has seven layers:
Layer 7—Application layer
Layer 6—Presentation layer
Layer 5—Session layer
Layer 4—Transport layer
Layer 3—Network layer
Layer 2—Data link layer; in this case, coupling elements are, for example: bridges and switches, in which case frames are units of this layer
Layer 1—Physical layer; in this case, coupling elements are, for example: hubs and repeaters, in which case bits are the units in the physical layer.

Layers one and two make it possible to design network access, in which case the protocols used here are, for example, Ethernet, token ring, FDDI and ARCNET.

Ethernet provides a multiplicity of options, only a small portion of which are often used in a specific application. In this case, the underlying hardware component in Ethernet is often identical and can therefore be actually used in a versatile manner. The overlying logical protocol components are partially also identical, but the differentiation also becomes greater, the more protocol layers have to be handled efficiently.

On the other hand, the costs involved in designing a communication controller with real-time tasks become higher and higher, with the result that it becomes more and more difficult to recoup these costs only with a few applications. It is possible to roughly estimate that the costs involved in using the powerfulness of a new technology double approximately every 3 to 4 years but the applications can be conventionally increased in the long run only by about 10%. In this respect, there is dependence, for example, on providing a design which satisfies diverse demands in order to thus cover a larger field of application with fewer designs. Adaptation to new circumstances is required for this purpose.

Examples of an approach, as selected in PROFINET®, repeatedly requiring additions are the substation applications in power networks and audio-video bridging and communication in medical applications. An easily modified synchronization protocol can be used in such application scenarios. The efficient IEEE 1588 V2 protocol is used, for example. However, this does not make it possible to efficiently forward synchronization frames by means of an ERTEC, for example, and a larger synchronization error occurs. The ERTEC is an industrial Ethernet ASIC and its manufacturer. It makes it possible to connect devices and systems to PROFINET® in a simple manner and without a large amount of effort. The ERTEC is an Ethernet controller with an integrated real-time switch and a 32-bit microprocessor specifically for industrial use.

A greater degree of flexibility can be achieved with the aid of an FPGA. For reasons of cost, it is necessary to change to an ASIC design after a certain number of units when successfully using the FPGA. However, changes can then no longer be carried out upon changing to an ASIC design. One disadvantage of the FPGA is sometimes a somewhat poorer performance than the ASIC design, in particular during memory access. In addition, it is often not simple to define a generic approach which is used to optimize both the ASIC design and an FPGA design. FPGAs often have a higher power loss than ASICs. The higher power loss may require a certain amount of adaptation. This solution is suitable, in particular, for starting up a technology and gathering initial field experience.

One approach for increasing the flexibility is to monitor the standard processing by means of a filter and then to process the particular frames using a software entity in a special microcontroller. This is achieved, for example, by powerful switches. However, delays occur in this case; in particular, the complete message is usually first received and then processed.

Possible embodiments of the invention emerge from methods having the features according to at least one of claims 1 to 9 and 16 and from a data converter according to claims 10 to 15.

In a data communication method which is based on a layer model, the layer model having a media-independent interface, a memory having one check bit or a multiplicity of check bits which are statically or dynamically set in particular, at least one check bit is checked during a memory access operation. The memory access operation is, in particular, a direct memory access operation, for example in a DMA process. The contents of a memory cell can be identified as entry to a function depending on whether or not the check bit has been set. The function may be, for example, particular processing of a received data frame, with the result that conversion to another communication protocol or to a particular communication protocol, for example, results therefrom. The function may also be a jump to another, in particular subsequent, check bit.

The data communication method can be used in an industrial automation environment. This consequently then also relates to a data converter. The industrial automation environment relates, for example, to automation components such as regulators, controllers, master computers, power converters, motors, sensors, etc. Such devices are connected to one another in terms of data technology. The methods described and a corresponding data converter can be used with this data connection.

In one refinement of the method, the direct memory access operation, that is to say the direct memory access process, is carried out in Ethernet-based communication.

In one refinement of the method, buffers of the direct memory access process dynamically change over. In this case, the dynamic changeover can be used when addressing the resource pool.

In one refinement of the method, a corresponding task is carried out following entry to the function, after which the procedure returns to the direct memory access process after the entry or task has been completed. The procedure can therefore return to a known DMA process.

In one refinement of the method, registers of the direct memory access process are changed as a result of entry to the function.

In one refinement of the method, the check bit is checked inside the layer model at a medium-independent interface. Such interfaces can be referred to as an MII interface.

In one refinement of the method, the check bit is checked in the physical layer or in the data link layer or between the physical layer and the data link layer.

In one refinement of the method, a plurality of steps are used to process a call, with the result that a FIFO is used for decoupling.

A data converter which can be used, in particular, to carry out the described method has an input and an output, an incoming data stream being converted by means of a converter in such a manner that an outgoing data stream which differs from the incoming data stream can be generated at an output, the data stream being converted on the basis of at least one function, selection of the function depending on the incoming data stream. In this case, the conversion relates to one or more data frames of the data stream, for example. Successive data frames can also be converted in a different manner, for example. The term “different” means, for example, that a data frame is converted according to a first protocol structure and a subsequent data frame is converted according to a second protocol structure which differs from the first protocol structure.

In one embodiment of the data converter, at least one of the data streams is part of a layer model, the layer model having a media-independent interface, the selection of the at least one function depending on the state of at least one check bit which is statically or dynamically set, the incoming data stream being converted into an outgoing data stream in a different manner depending on the state of the check bit.

In one embodiment of the data converter, a multiplicity of check bits are provided, the query of the check bits being cascaded. The check bits are read in succession. In another embodiment, the check bits are read in a parallel manner.

In one embodiment of the data converter, the check bits are cascaded in such a manner that the state of a further check bit is queried on the basis of the set state of a check bit.

In one embodiment of the data converter, the data converter can be programmed in such a manner that different check bits can be queried.

In one embodiment of the data converter, the data converter is programmed in such a manner that different functions are programmed. The different functions are activated with differently set check bits.

The invention is described by way of example below using different illustrations. The embodiments according to the examples show possible refinements of the invention, other combinations of features also being possible and features of different examples being able to be combined. In the drawings below:

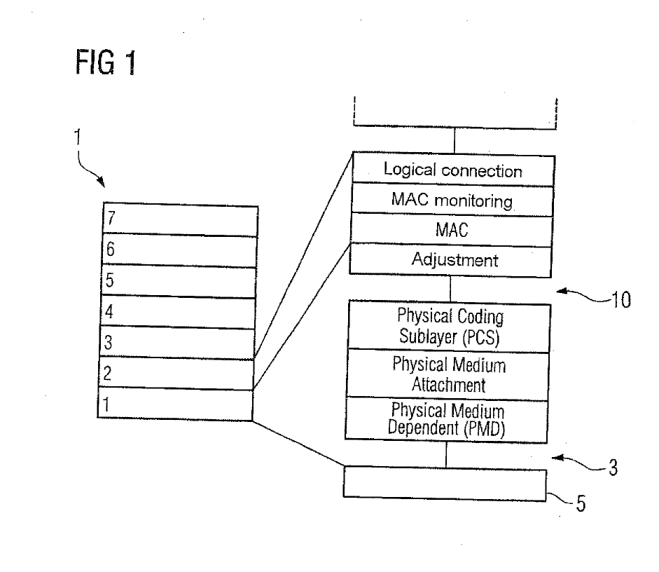

FIG. 1 shows an OSI layer model;

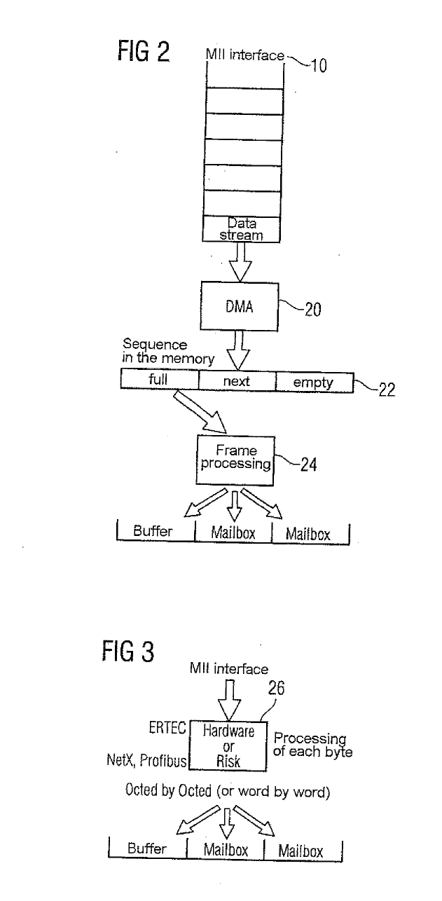

FIG. 2 shows a direct memory access operation;

FIG. 3 shows an MII interface in conjunction with an ERTEC unit;

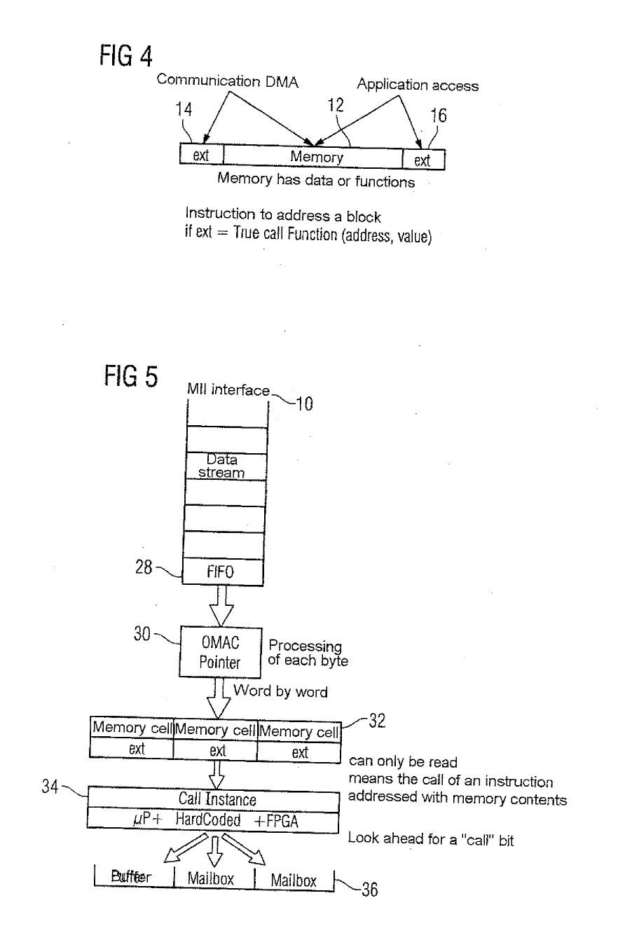

FIG. 4 shows an expansion of a frame by a first check bit ext and a second check bit ext, respectively at the start and end of the memory area;

FIG. 5 shows a communication method using an OMAC (object memory access controller);

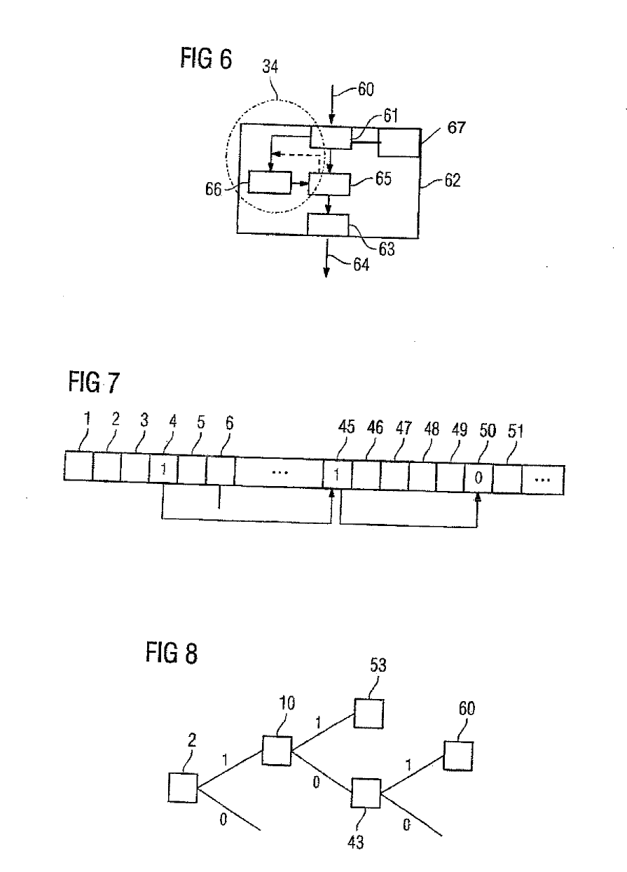

FIG. 6 shows a data converter;

FIG. 7 shows a jump scheme for check bits; and

FIG. 8 shows a check bit tree.

The illustration according to FIG. 1 shows layers 1 of the OSI layer model. This layer model has the layers/levels 1 to 7:
1 Physical layer
2 Data link layer
3 Network layer
4 Transport layer
5 Session layer
6 Presentation layer
7 Application layer

The medium for transmitting the communication data is structurally situated below the physical layer. As illustrated in FIG. 1, the physical layer can be subdivided into further subsections. For the medium, there is a medium-dependent interface 3 (MDI). The physical layer has the following sections: a PMD (physical medium dependent), a PMA (physical medium attachment) and a PCS (physical coding sublayer). In the refinement illustrated in FIG. 1, the medium-independent interface MII 10 is before an adjustment. According to FIG. 1, the data link layer has three subsections: MAC (media access control), MAC monitoring and the logical connection.

The illustration according to FIG. 2 shows a direct memory access (DMA) operation 20 in conjunction with an MII interface 10. The term “direct memory access (DMA)” denotes a type of access operation which directly accesses a memory via a bus system. The DMA receives a data stream via the MII. The DMA writes the received data to a memory 22. The frames are processed (so-called frame processing) from the memory 22. From the frame processing, the data are forwarded to areas such as buffers and the mailbox. The illustration according to FIG. 2 is therefore a type of two-stage processing. A data stream is first of all processed (stream processing), after which processing from the buffer (buffer handling) is carried out.

Another approach is based, in terms of key features, on a principle which is used in PROFIBUS®, as well as by Hilscher for the NetX architecture. The data stream from the MII interface can also be locked via a microsequencer 26. This allows a high degree of flexibility but also requires a high computation power of generally more than 2 instructions per data bit to be processed. This means that already more than 400 MIPS have to be provided for each port for fast Ethernet. However, the extreme demands of forwarding in an Ethernet bridge could result in performance bottlenecks here because a computation power of more than 1600 MIPS is already required for a 4-port switch, for example. The basic structure is illustrated in FIG. 3. The data stream is passed to an ERTEC—this is an industrial Ethernet ASIC. Alternatively, the data stream can also be passed to a risk processor. Both are units which process each bit of the data stream. As a result of the processing, the data are then differentiated and the data stream is split into the buffer and the mailboxes shown. This methodology requires a high computation power. 4 to 8 instructions per bit may be required (peak).

Another approach is to monitor a memory segment, as was introduced in PROFIBUS with SPC3 and is now also being carried on by other systems such as EtherCAT. In this case, a local access operation can also be concomitantly taken into account. This method can be used to ensure consistency.

In methods such as those described in FIG. 2 and FIG. 3, only processing operations which relate to interactions on the communication side are largely carried out. In another approach, processing operations which include an application side may also be carried out. This makes it possible to directly allocate data from the data stream to applications in order to thus process the data more quickly, for example. This is important, in particular, when incorporating DMA technology.

The DMA method described and the direct processing method can be combined with one another. In addition, a local interaction may also be concomitantly included. This local interaction is a particular application, for example. In order to achieve this combination, the memory 12 is expanded, for example by at least two additional bits 14, 16. These bits can then be statically or dynamically set. If the DMA process now encounters this memory cell, a check is carried out in order to determine whether this bit has been set. If it has been set, the contents of the memory cell are considered to be entry to a function. The corresponding task can now be carried out; completion is then a normal return to the DMA process, in which case the registers of the DMA process can be changed by the procedure. The illustration according to FIG. 4 illustrates this situation.

An instruction for the address block can read as follows, for example:
if ext=True call Function (address, value)

This is therefore a function call for the function “Function” if ext (that is to say the bit 14, for example) has been set (true). The bit ext which has or has not been set is a check bit. A function call may take place or else may be omitted depending on this check bit.

This method has the advantage that the complexity of the communication controller is considerably reduced. The following advantages may also be important:
the actual DMA process takes place autonomously and does not require any computation power;
a call can take place precisely when an interaction is required;
the application and communication are coordinated by this process;
no state variables need to be conveyed and there is no need for any jumps in the program.

The advantages of this method can be shown using the example of Ethernet and PROFINET. First of all, it must be ensured that the DMA process is executed with sufficient performance. For many Ethernet applications, it is possible to work in a 16-bit infrastructure. There is thus a spacing of at least 160 ns between two calls. However, a processing operation may use a plurality of steps, with the result that a FIFO is required for decoupling. The application process can also be braked from a particular FIFO depth, for example. It is also advantageous if buffers of the DMA process are dynamically changed over. The correct resource pool can thus be addressed very quickly.

In the case of DMA, a speed aspect is the look ahead which can be advantageously implemented in this process by reading the ext bit (that is to say the check bit) of the next memory cell in advance. The procedure can therefore be immediately initiated with the DMA pulse.

The illustration according to FIG. 5 shows the use of an OMAC (object memory access controller). The OMAC is designed for byte-based processing of the data. The MII interface 10 acts as the input of the process/method. The data stream reaches a FIFO 28. From there, the data are passed to the object memory access controller and are transferred to different memory cells 32 word by word by means of a pointer. Ext relates to a read access operation (read only). If the bit ext has been set, this means a call, in which case a function (procedure) which can be assigned the memory contents needs to be called. The call instance 34 can be implemented in various ways—on the one hand using a microprocessor and/or with an ASIC/HardCoded and/or with an FPGA. The call instance (that is to say a type of call function) is then followed again by the possible splitting of the data into buffers and mailboxes.

The process described is shown using a PROFINET frame with DFP. In this case, the special feature of Inbound is that the receiving and transmitting DMA processes can be coordinated via a resource. In this case, only the receiving section is illustrated in the figure and in the preceding figures. A transmitting section can be implemented in a similar manner to the receiving sections but is not illustrated here.

In the method described, a destination MAC address is advantageously initially evaluated. Access to the database containing the MAC addresses is critical, in particular, in this case; this can be simplified by means of suitable hardware support if necessary. The result would then be checked in the source address. Further system-relevant variables are also VLAN, Ethertype, and the frame ID in PROFINET.

A 50-MHz processor (or else a processor which operates at more than 50 MHz) can advantageously suffice to process an MII interface data stream. The processing speed of the incoming data is increased in comparison with conventional architectures in the stated method.

The following method sequence can be implemented, for example:

| | | | | |
|---|---|---|---|---|
| Preamble | | | should be implemented in | PreDetect |
| | | | hardware | |
| SFD | | | if (!SFD), then pointer [symbol] | SFD |
| DA1 | | | | |
| DA2 | | | | |
| DA3 | | | | |
| DA4 | | | | |
| DA5 | | | | |
| DA6 | 20 | Call | MCFF => FrameID in list | =>change pointer |
| SA1 | | | | |
| SA2 | | | | |
| SA3 | | | | |
| SA4 | | | | |
| SA5 | | | | |
| SA6 | 8 | Call | Check own address | |
| VLAN type | | | | |
| VLAN type | 2 | Call | Vlan? | |
| VID-Pri | | | | |
| VID-Pri | 10 | Call | Which priority => queue | =>change pointer |
| EtherT | | | | |
| EtherT | 8 | Call | | |
| Frame ID | | | | |
| Frame ID | 8 | Call | Frame for this node, DFP | |
| DCS | | | | |
| DCS | 3 | Call | | |
| PosLen | | | | |
| PosLen | 2 | Call | | |
| Cycle | | | | |
| Sts | 3 | Call | | |
| Data1 | | | | |
| Data2 | | | | |
| Data3 | | | | |
| Data4 | | | | |
| DCS | | | | |
| DCS | 3 | Call | | |
| . . . | | | | |
| End | 4 | Call | | |
| FCS1 | | | should be implemented in | |
| | | | hardware | |
| FCS2 | | | | |
| FCS3 | | | | |
| FCS4 | | | Hardware | |

The instruction set of the microcontroller (microprocessor) advantageously contains the following, for example:
powerful bit instructions
indirect addressing
a plurality of register sets for the different interfaces
addition
subtraction
comparison operations with integrated bit masks
pipelining
skipping of instructions
16-bit, 32-bit and/or 64-bit registers

The approach described here reduces the characteristic variable of performance, which is so important, for the required microcontroller. A 250-MHz machine would, for example, impose considerably more critical demands than a 50-MHz technology which can be used here.

The method described above is essentially a combination of the pure DMA approach and a microprogrammed approach or an approach implemented using logic. A changeover mimic means is implemented via the memory.

One problem could be that data and instructions reside together in a memory and gaps occur when storing the original data in the memory. However, this can be reduced by storing the call values in a shadow memory. This would signify a greater reduction of memory. Both types, the preliminary memory blocks SA, VLAN, Ethertype in a shadow memory and the downstream buffers without a shadow memory, are possibly required.

The implementation allows adaptation to other RT Ethernet protocols. The limits, but also the complexity, lie in the capacity and instructions of the microcontroller, with the result that a very realistic estimate and an efficient instruction set can be implemented here.

The above-described principle of a virtually intelligent DMA can also be turned round. This means that it is possible to design a programmable unit with integrated DMA. In principle, this programmable unit, that is to say an FPGA or else an ASIC for example, can perform in a similar manner. However, the advantage of concomitantly including the application may be lost. The operations of setting up the DMA and handling branches reduce the performance. In one embodiment, however, a methodology in which DMA and a microprogrammed solution are combined by signaling the DMA end by means of an additional flag can be selected in the case of DMA which has been “set up”.

The illustration according to FIG. 6 shows a data converter 62 which has an input 61 and an output 63. The input 61 is intended for an incoming data stream 60. The output 63 is intended for an outgoing data stream 64. The incoming data stream 60 is, for example, a data stream which is usually provided in a DMA process. The outgoing data stream 64 is, for example, a data stream which has a particular protocol structure. This protocol structure may be based, for example, on a CAN bus protocol, a Profibus protocol, an Ethernet protocol or the like. The data converter 62 is used to convert the data information in the incoming data stream 60 in such a manner that the protocol structure of the incoming data stream 60 differs from the protocol structure of the outgoing data stream 64. The conversion is carried out using a converter 65 which can also be referred to as a functional element converter 65. The conversion in the converter 65 depends on a function 66. The function 66 is one function or a multiplicity of functions. The functions are selected, in particular, by setting one or more bits in the incoming data stream 60. The corresponding bits (check bits) are read in the data converter 62, and a particular function for influencing the conversion of the data stream is selected depending on the contents of the bits (0 or 1). The function can be stipulated or can be changed. The function can be changed, for example, by using a microprocessor or a microprocessor circuit or an FPGA.

The function of the data converter can therefore be changed. Depending on the programmed function 66, it is possible to change the outgoing data stream 64 in such a manner that it corresponds to or complies with different protocol types. Before the data converter is reprogrammed, the latter is trained, for example, to output a CAN-bus-based data stream 64, the outgoing data stream 64 corresponding to the data structure of a Profinet bus after the data converter 62 has been reprogrammed.

As a result of the fact that the data converter can be programmed, that is to say can be changed, it can also be referred to as a hybrid memory interface, the input side, in particular, being based on a DMA process. The illustration according to FIG. 6 also shows a possibility in which the call instance 34 can be structurally implemented.

A function can be selected in different ways. For example, the check bits can be tapped off at the input 61 or from the converter 65 itself.

The illustration according to FIG. 7 shows a jump scheme for check bits. Bits 1 to 6 and 45 to 51 are illustrated. Further bits are symbolically represented by dots. Check bits 4, 6, 45 and 50 are illustrated. A check bit can be checked, for example, individually per se, for example the bit 6 according to FIG. 7. It is also possible for particular check bits to refer to further check bits for further checking. If, for example, the check bit 4 has been set, the fact that the check bit 45 subsequently needs to be checked is stored in a checking scheme. If the check bit has been set to 0, the check bit 45 is not checked. In the present case, the check bit 45 is occupied by 1, with the result that the check bit 50 is subsequently checked according to a predefined checking scheme which can also be programmed and modified. The check bit 50 has been set to 0. A function for converting the incoming data stream can subsequently be selected depending on the contents of the check bits, with the result that the outgoing data stream is converted in such a manner that it complies with the predefined requirements or structures.

The illustration according to FIG. 8 shows a check bit tree. According to FIG. 8, the bits 2, 10, 43, 53 and 60 are check bits. In this case, FIG. 8 indicates a representation which differs from FIG. 7. A further query of subsequent bits is carried out depending on the state (1 or 0) of the check bits. Check bits are thus cascaded. Messages in the incoming data stream can be queried in different ways depending on the state of particular bits. The manner in which the different check bits are cascaded and/or the check bits themselves can advantageously be subsequently changed by programming the data converter. Furthermore, in one refinement, it is also possible for the check bits to be permanently programmed, with the result that, for example, the bits 7, 22 and 23 are check bits, but the function used to convert the data stream in the data converter is freely programmable. The conversion depends, for example, on the structure of the incoming data stream and on the desired structure of the outgoing data stream.

1-16. (canceled)

17. A data communication method based on a layer model having a media-independent interface, a memory having at least one check bit which is set statically or dynamically, comprising the steps of:
checking the at least one check bit during a direct memory access process, and
identifying a contents of a memory cell as being an entry to a function depending on whether or not the at least one check bit has been set.

18. The method of claim 17, wherein the direct memory access process is performed in an Ethernet-based communication.

19. The method of claim 17, wherein buffers of the direct memory access process are switched over dynamically.

20. The method of claim 19, wherein dynamic switchover is used when addressing a resource pool.

21. The method of claim 17, further comprising the steps of:
performing a corresponding task following an entry to the function, and
returning after completion of the entry or the task to the direct memory access process.

22. The method of claim 17, further comprising the step of changing registers of the direct memory access process as a result of entry to the function.

23. The method of claim 17, wherein the at least one check bit in the layer model is checked at a medium-independent interface.

24. The method of claim 23, wherein the check bit is checked in the physical layer or in the data link layer or between the physical layer and the data link layer, or a combination thereof.

25. The method of claim 17, wherein processing a call includes a plurality of steps which are decoupled by a FIFO.

26. A data converter comprising:
an input and an output,
a converter receiving at least one incoming data stream from the input, with the converter generating at an output at least one outgoing data stream different from the incoming data stream, and
at least one function residing in the data converter and controlling conversion of the at least one incoming data stream in the converter, wherein the at least one function is selected depending on the at least one incoming data stream.

27. The data converter of claim 26, wherein at least one of the data streams is part of a layer model, the layer model having a media-independent interface, the selection of the at least one function depending on a state of at least one check bit which is statically or dynamically set, the at least one incoming data stream being converted into the at least one outgoing data stream depending on the state of the check bit.

28. The data converter of claim 27, wherein a plurality of check bits is provided, and wherein querying the plurality of check bits is cascaded.

29. The data converter of claim 28, wherein the check bits of the plurality of check bits are cascaded in such a manner that a state of an additional check bit is queried based on a state of a previously queried check bit.

30. The data converter of claim 29, wherein the data converter is constructed to query different check bits.

31. The data converter of claim 26, further comprising a memory, wherein a bus system connected to the input directly accesses the memory via the input, and wherein the at least one function is programmed according to an input signal from the bus system.

32. The data converter of claim 26 for use in carrying out a data communication method based on a layer model having a media-independent interface, a memory having at least one check bit which is set statically or dynamically, comprising the steps of checking the at least one check bit during a direct memory access process, and identifying a contents of a memory cell as being an entry to a function depending on whether or not the at least one check bit has been set.
